(19) United States
(12) Patent Application Publication
(10) Pub. No.: US 2025/0356137 A1
(43) Pub. Date: Nov. 20, 2025

(54) Language Translation System

(71) Applicant: Prismatext Inc., Anchorage, AK (US)

(72) Inventor: Zachary Erving, Anchorage, AK (US)

(73) Assignee: Prismatext Inc., Anchorage, AK (US)

(21) Appl. No.: 19/281,418

(22) Filed: Jul. 25, 2025

Related U.S. Application Data
(62) Division of application No. 18/352,169, filed on Jul. 13, 2023.
(60) Provisional application No. 63/388,752, filed on Jul. 13, 2022.

(51) Int. Cl. G06F 40/40

(52) U.S. Cl. CPC G06F 40/40

(57) ABSTRACT

Representative implementations of devices and techniques provide an adaptable electronic book and a process for producing and updating adaptable electronic books. The electronic books are published in a first language and contain selected text translated into a second language. For instance, by reading a sentence or paragraph in a familiar language and encountering words or phrases within the sentence or the paragraph in the second language, the electronic books can be used by the reader to learn the second language.

### PRIORITY CLAIM AND CROSS-REFERENCE TO RELATED APPLICATION

This application is a divisional of U.S. patent application Ser. No. 18/352,169, filed Jul. 13, 2023, which claims the benefit under 35 U.S.C. § 119(e)(1) of U.S. Provisional Application No. 63/388,752, filed Jul. 13, 2022, both of which are hereby incorporated by reference in their entirety.

### BACKGROUND

Electronic books that are published in a first language, but with selected words translated to a second language, are produced for the general purpose of helping the reader to learn the second language. Examples of such eBooks are currently available for purchase via e-commerce sites. Customers can purchase titles in the language variant of their choice, after which they can download their book to their electronic device or have it delivered to an e-reader, for example.

One issue with current language-training eBooks is a slow update pipeline. For instance, updating a book or correcting errors in a book is currently a manual process, which is both tedious and time-consuming. A related problem includes fixed-state eBooks. For example, once an eBook is downloaded or delivered to a customer, the downloaded eBook is effectively removed from the update pipeline. Once the eBook has been updated at the source, the customer can be notified of the update, so that they can re-download the eBook or re-add add the eBook to their device. However, this has the unfortunate consequence of cluttering the customer's digital library with multiple versions of the same title and/or needlessly complicating their workload for staying current.

Another issue includes the difficulty for the eBook producer to protect its intellectual property (IP) in the language-training eBook. That is, once the eBook has been produced and downloaded, in many cases the customer can freely distribute the eBook to any number of people or post it online. The result is a loss in revenue to the eBook producer, which can drive up the initial cost of each eBook or diminish the ability of the producer to publish an extensive collection of titles. Further, it is difficult for the eBook producer to protect the IP of the publishers and authors of the original work.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure. Shapes, designs, and/or dimensions shown in the illustrations of the figures are for example, and other shapes, designs, and/or dimensions may be used and remain within the scope of the disclosure, unless specified otherwise.

FIG. 1 is a graphic diagram showing an example language translation system, according to an embodiment.

FIG. 2 is a block diagram showing an example product supply chain overview, according to an embodiment.

FIG. 3 is a block diagram showing an example production overview, according to an embodiment.

FIG. 4 is a flowchart showing an example process of staging a book, according to an embodiment.

FIG. 5 is a flowchart showing an example process of charging a staged book, according to an embodiment.

FIG. 6 is a flowchart showing an example process of blending a charged book, according to an embodiment.

FIG. 7 shows a loop of the flowchart of FIG. 3, according to an embodiment.

FIG. 8 shows an example of metadata associated with a book, according to an embodiment.

FIG. 9 shows an example of metadata associated with a chapter, according to an embodiment.

FIG. 10 shows an example of metadata associated with a paragraph, according to an embodiment.

FIG. 11 shows an example of metadata associated with a sentence, according to an embodiment.

FIG. 12 shows an example of metadata associated with a chunk, according to an embodiment.

FIG. 13 shows an example of metadata associated with an instance, according to an embodiment.

FIG. 14 shows an example of metadata associated with a translation, according to an embodiment.

FIG. 15A shows an example of a sentence prior to translation and blending.

FIG. 15B shows an example of deconstructing the sentence of FIG. 15A, according to an embodiment.

FIG. 16 shows an example of the deconstruction of FIG. 15B, with an added attribute inserted, according to an embodiment.

FIG. 17 shows an example of the deconstruction of FIG. 16, with references to translation objects inserted, according to an embodiment.

FIG. 18 shows an example of translation objects, according to an embodiment.

FIG. 19A shows an example blend of the sentence of FIG. 15A at a first level, according to an embodiment.

FIG. 19B shows an example blend of the sentence of FIG. 15A at a second level, according to an embodiment.

FIG. 19C shows an example blend of the sentence of FIG. 15A at a third level, according to an embodiment.

### DETAILED DESCRIPTION

### Overview

Representative implementations of devices and techniques provide an adaptable electronic book and a process for producing and updating adaptable electronic books. In various embodiments, the electronic books multi-language blended, or in other words, the electronic books are published in a first language and contain selected text translated into a second language. For instance, by reading a sentence or paragraph in a familiar language and encountering words or phrases within the sentence or the paragraph in the second language, the electronic books can be used by the reader to learn the second language.

The electronic books are adaptable and can have the benefit of some human or artificial intelligence. For instance a copy of an electronic book may be published in a multitude of arrangements, to contain more or fewer portions of text translated to the second language based on input directly or indirectly from the reader. For instance, if the reader is a beginner, fewer words or phrases may be translated into the second language than if the reader is a more advanced student of the second language. In another example, if the reader is a beginner, easier words or phrases may be translated into the second language than if the reader is a more advanced student. In some examples, the density of translated words or phrases to non-translated words or phrases may change (e.g., increase at a selected rate) as the reader progresses through the electronic book.

In various embodiments, the electronic books can be distributed to consumers via a web application, or like interface, which can contain a library of language blended electronic books, from staging to publishing to updating, as well as keep all relevant IP within its confines. The consumer will access the electronic book (via a public key) through the application, rather than downloading the electronic book to the user's device. This will remove the need for users to manually add or deliver their purchases to separate applications and devices. Since released electronic books will be maintained (e.g., updated, corrected, etc.) at a server and published to the web application, the book that the consumer is reading is always the most up-to-date and latest release of that book.

Techniques and devices are discussed with reference to example electronic books. However, this is not intended to be limiting, and is for ease of discussion and illustrative convenience. The techniques and devices discussed may be applied to electronic or digital media of all kinds and types, such as books, magazines, newspapers, advertisements, articles, and the like, and remain within the scope of the disclosure. For the purposes of this disclosure, the generic term “eBook” is used to indicate any or all of the above. Alternately, the techniques and devices may be applied to other digital media types, including audio books, other audio programming or content (including music-related content), video programming or content, and so forth.

Additionally, the techniques and devices are discussed and illustrated generally with reference to a web-based application for distribution of eBooks. This is also not intended to be limiting. In various implementations, the techniques and devices may be employed with any or all other applications having the capability for connectivity to other networks or communication means in a standalone form or with the use of an intermediary application, interface, device, or system, using currently developed technologies or emerging or future technologies.

Further, the process steps illustrated in the figures may vary to accommodate various applications of the techniques and devices. In alternate embodiments, fewer, additional, or alternate process steps may be used and/or combined to form a technique or process having an equivalent function and operation.

Implementations are explained in more detail below using a plurality of examples. Although various implementations and examples are discussed here and below, further implementations and examples may be possible by combining the features and elements of individual implementations and examples.

### Example Embodiments

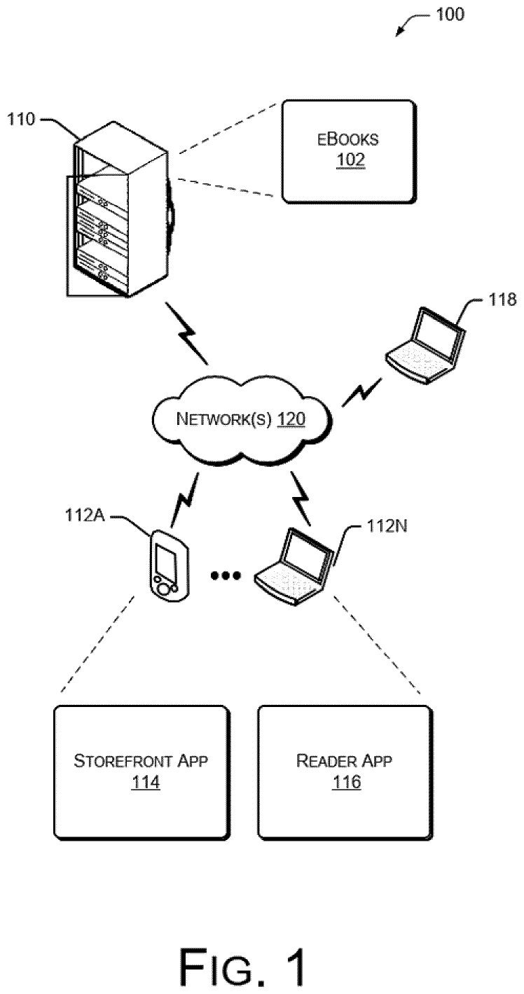

FIG. 1 illustrates an example embodiment of a language translation system 100 according to various non-limiting configurations. The example language translation system 100 includes a server 110 communicatively coupled to at least one network 120, such as the Internet, for example. The language translation system 100 and/or the server 110 may be coupled to another network (one or more) or to an alternate network to perform the disclosed functions (or equivalent functions).

In an embodiment, the server 110 comprises a computing device or a series of communicatively coupled computing devices, which includes an electronic memory storage capability (i.e., integral and/or remote (e.g., networked) memory storage, which may include cloud storage). In some examples, the server 110 comprises a third-party web-hosting service server. In other examples, the server 110 comprises dedicated computational and storage equipment, with resources specifically devoted to the system 100.

In various embodiments, the server 110 stores the content for the language translation system 100, including eBooks 102 in various stages of production and published eBooks 102 to be consumed. In some examples, the eBooks 102 are stored as hypertext markup language (HTML) documents, extensible markup language (XML) documents, various electronic book formats, or the like, and are tagged, linked, and navigable, and so forth, for quick access by a browser-type application. The eBooks 102 can be stored in directories at the server 110, and may be delineated by chapters. The server 110 may also store the content for distributing the eBooks 102, such as content for presentation of a storefront 114, and related or associated content for communication with users and processing purchases and orders, and may also include content for a web-based reader application 116, or the like.

In some embodiments, the computational capability of the server 110 is used by the system 100 to produce the eBooks 102, as discussed further below. For example, the server 110 may include hardware and software for processing artificial intelligence (AI) routines and machine learning algorithms, and the like, and/or for executing process steps for producing the eBooks 102, as discussed further below. The hardware and/or software (or firmware) may include proprietary algorithms and/or applications for producing the eBooks 102. In other words, the algorithms and/or applications comprise the content creation means, whereby the eBooks 102 are produced. The algorithms and/or applications may be stored and/or executed at the server 110 or at one or more remote computing and/or storage systems.

In various embodiments, management control of the system 100 may be integral to or remote from the server 110. For instance, management control of the system 100 and the processes disclosed herein may be executed at the server 110 and/or at a remote terminal or device. In such embodiments, management control of the system 100 and/or the server 110 may be executed via a networked device 118, or the like. For example, the algorithms and/or applications for producing the eBooks 102 may be accessible from a web browser (or other application) on the networked device 118, or the like. In various examples, the networked device 118 comprises a personal computer, mobile phone, tablet, terminal, or like computing device capable of communicating over the network.

One or more consumer devices 112 (e.g., 112A-112N) can also be communicatively coupled to the network 120 directly or indirectly. The consumer device 112 can comprise an electronic book reader, mobile phone, tablet, personal computer, or other device capable of communicating over the network, downloading an eBook 102, and displaying the eBook 102 for consumption by the user.

The consumer device 112 includes the capability to run web applications and/or downloadable applications (“apps”). For example, the consumer device 112 may include a web browser or like application. The consumer device 112 can also include an operating system (or like control application) and a memory for storing the operating system and downloaded content. In some examples, the eBook 102 to be consumed is streamed to the consumer device 112, or partially downloaded to the consumer device 112, rather than being fully downloaded to the consumer device 112. In other examples, one or more entire eBook 102 titles are downloaded to the consumer device 112. In such examples, the eBooks 102 may be accessed through the reader app 116 using a public key. In such a case, the eBooks 102 may not be accessible if copied or accessed in another way or on another device.

In various examples, the consumer device 112 is capable of accessing a storefront app 114, which may comprise a web app, a downloaded app, a native application, or the like. The storefront app 114 comprises a portal for purchasing or otherwise gaining authorization to consume content such as an eBook 102 using the consumer device 112. The storefront app 114 can manage access to the eBooks 102 stored on the server 110. The storefront app 114 can display a bookshelf (or directory, table, listing, etc.—in any form desired) showing a selection of published eBooks 102 for purchase (or other authorization) via the storefront app 114. In other words, the storefront app 114 can act as a bridge between the library of eBooks 102 available on the server 110 and the reader app 116 at the consumer device 112, making the eBooks 102 available to read by the user. Once an eBook is purchased (or otherwise authorized for consumption) via the storefront app 114, the storefront app 114 can cause the eBook 102 to be partly or fully downloaded to the consumer device 112, streamed to the consumer device 112, and so forth.

In various examples, the consumer device 112 is capable of accessing a reader app 116, which may comprise a web app, a downloaded app, a native application, or the like. The reader app 116 comprises an interface for consuming (e.g., reading) purchased (or otherwise accessed) eBooks 102. The reader app 116 can display an eBook 102 at a screen of the consumer device 112, showing text and illustrations/graphics/photos for example, and may also provide audio and/or video in some cases. Additionally, the reader app 116 may provide audio and/or video as an accessibility feature, for instance reading the eBook 102 (e.g., voice-over, recorded audio, etc.), and so forth.

In an embodiment, the reader app 116 may include functionality to download an eBook 102 from the server 110, but may not include functionality to purchase an eBook 102 from the server 110. However, the reader app 116 may include a link or other pathway for spawning the storefront app 114, so that the user can make purchases via the storefront app 114. In some cases, the reader app 116 includes the digital key portions used to unlock access to eBooks 102 purchased via the storefront app 114.

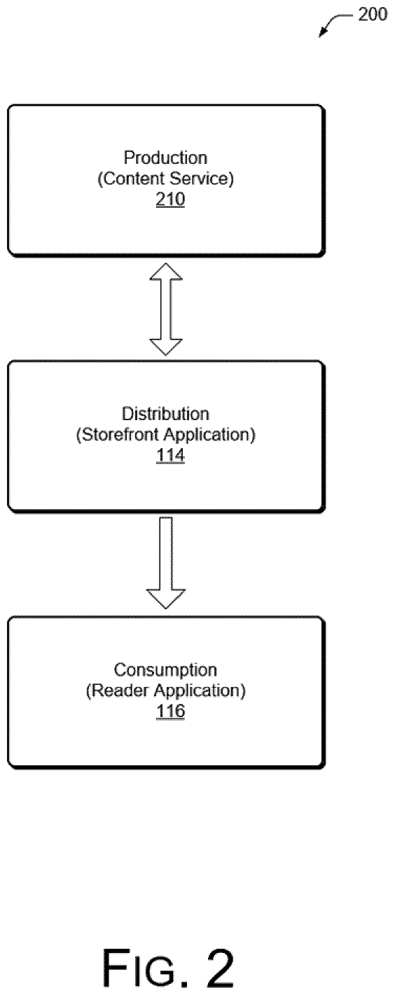

FIG. 2 illustrates an example embodiment of a supply chain 200 for the language translation system 100, according to various non-limiting configurations. In an embodiment, the supply chain 200 includes Production 210, Distribution 114, and Consumption 116. In other embodiments, the supply chain 200 may include additional or alternate components for providing the disclosed devices and techniques.

As discussed above, the Distribution component can comprise the storefront app 114, or the like, and the Consumption component can comprise the reader app 116, or similar. Other distribution and consumption components are also possible, and remain within the scope of the disclosure. As shown in FIG. 2, in an embodiment, the distribution component (e.g., storefront app 114) has access to the production component (e.g., the server 110) and the consumption component (e.g., reader app 116) has access to the distribution component 114, however the consumption component 116 may not have access to the production component 210, except through the distribution component 114. Also, as noted with the arrow between the distribution component 114 and the production component 210, eBooks 102 are made available to the distribution component 114 when prepared and published at the production component 210, and may be recalled back to the production component 210 for updates and/or corrections as desired. After any updates and/or corrections, eBooks 102 are again made available at the distribution component 114 for stream or download (for example) to the consumption component 116.

### Example Production

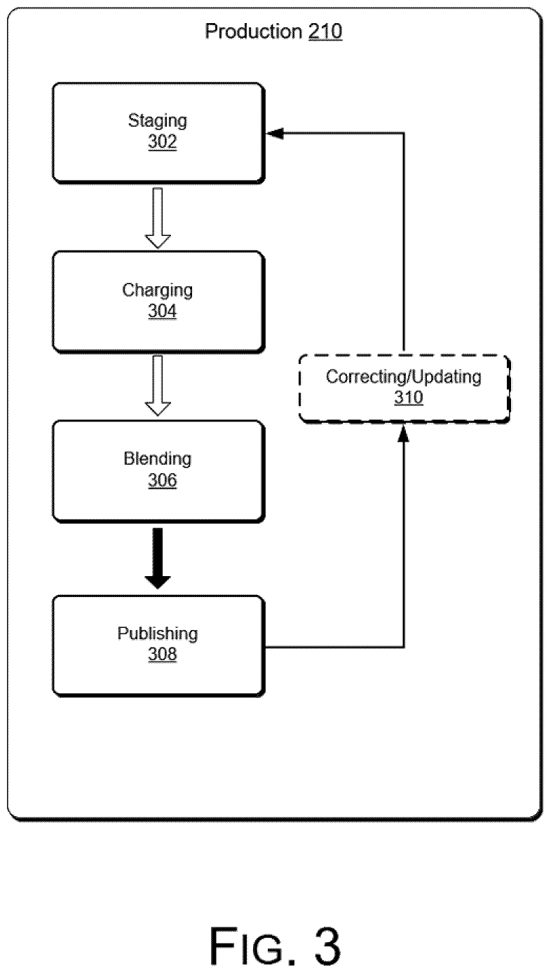

Much of the remainder of the disclosure will be directed to aspects of Production 210, with reference to FIGS. 3-19. The order in which the process(es) are described is not intended to be construed as a limitation, and any number of the described process blocks can be combined in any order to implement the process(es), or alternate processes. Additionally, individual blocks may be deleted from the process(es) without departing from the spirit and scope of the subject matter described herein.

The process(es) can be implemented in any suitable hardware, software, firmware, or a combination thereof, without departing from the scope of the subject matter described herein. In alternate implementations, other techniques may be included in the process(es) in various combinations, and remain within the scope of the disclosure.

Referring to FIG. 3, Production 210 refers to the stages, techniques, and components of producing eBooks 102 for consumption by a user. In various examples, Production 210 comprises “blending” to form “variants,” which are eBooks 102 that have a blend of content in at least a first language and a second language.

For example, blending includes determining which words and phrases of a source work or composition (e.g., an original work or an existing title) composed or published in a first language are to be exchanged (i.e., substituted in place) for translations of the selected words and phrases in a second language, to form the variant. Since any particular eBook 102 title can be formed to have a multitude of different blends of the first language and the second language, depending on which words and phrases have been substituted in from the second language, there can be a multitude of different variants of a particular title. This is discussed in more detail below. It is also conceivable that more than two languages may be included in an eBook 102, with multiple languages used to blend the variants.

Referring to FIG. 3, the following stages of Production 210 are illustrated: Staging 302, Charging 304, Blending 306, and Publishing 308. Also shown is a Correcting/Updating stage 310, which entails making corrections or updates to an eBook 102, often after the eBook 102 has been published. In other embodiments, Production 210 may include additional or alternate stages or components for providing the disclosed devices and techniques.

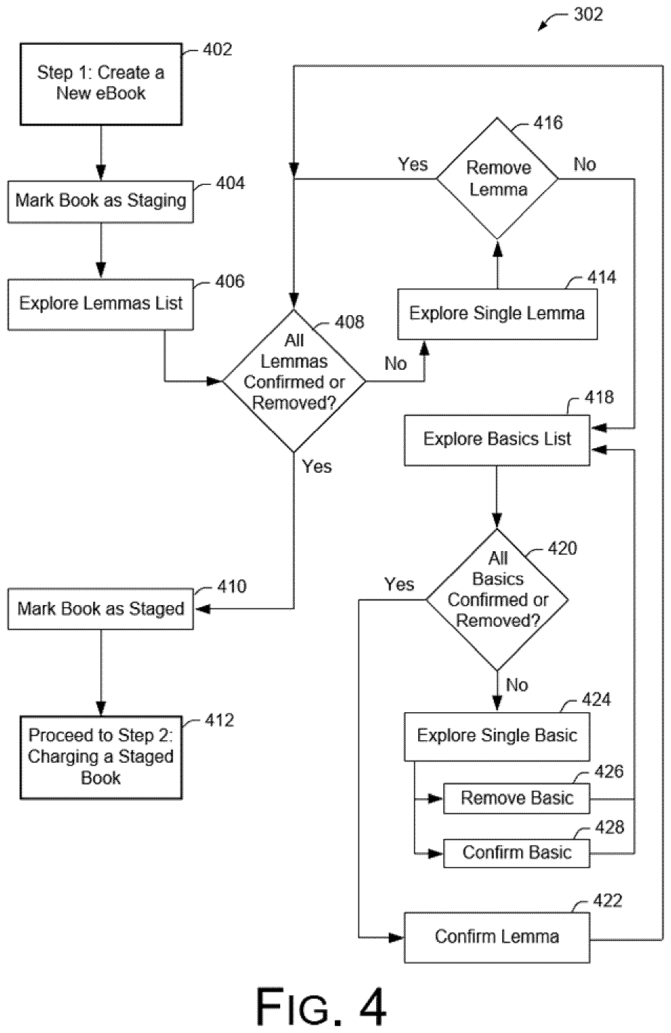

Referring to FIG. 4, a flowchart illustrates an example process of Staging 302, according to an embodiment. In various implementations, the process of Staging 302 can be performed at the server 110, or a like computing device. For instance, the process of Staging 302 can be accomplished at a hardware computing device (such as the server 110) with the aid of one or more of software, firmware, additional hardware, peripheral devices, a network connection, one or more electronic data storage components, and so forth. In some embodiments, the steps of the process of Staging 302 can be implemented via computer-readable instructions executed at a hardware computing device (e.g., server 110).

The process of Staging 302 initializes the creation of a new eBook 102. At block 402, an existing title or an original work or composition (“book”) is introduced to the process of Staging 302. The initialization and introduction may include uploading and/or digitizing the book into one or multiple digital text files, such as HTML, XML, or the like. In an embodiment, each book begins as one or more plain text files (e.g., UTF-8) delineated by chapter, for example, which may be compressed (e.g., *.zip, or the like).

The file or files are processed by the server 110, including various natural language processing (NLP) tasks, which can include artificial intelligence (AI), machine learning, and like processes, wherein the book data from the file or files are parsed across several different database tables. In other words, the book is broken apart into smaller and smaller pieces, down to individual sentences that are stored in fields of the database tables. This process makes it easier to edit sentences in isolation, so that when a book is being updated and reconstructed, all of the components can be put back together in the right order.

The process of Staging 302 may be performed on individual chapters of the book. In such a case, each chapter may have a separate digital file, and each subsequent block or step in the Staging process 302 may be performed on each chapter file. At block 404, the process includes marking the book file(s) as “Staging,” which can include attaching a tag to the book file(s).

At block 406, the process includes creating a list of the lemmas contained in the book file, by chapter or by book. Lemmas include the “head entry” or root word from which all variations of a given word come (e.g., happy is the lemma for happier, happiest; be is the lemma for was, are, and is; think is the lemma for thinks, thinking, and thought). Staging 302 can include pruning the lemmas from a book or a chapter, minimizing the chance for errant strings of text to be treated as normal. Each lemma in a list associated to a chapter (or the book) is either confirmed as a lemma to be linked to a translation in at least one language, or is removed from the list of lemmas. As each lemma in the list is subsequently examined, at block 408, the process includes determining whether any lemmas remain to be examined.

If all lemmas on the list (for each chapter or for the book) have been examined, the book is marked as “Staged,” at block 410. This can include adding a tag to the chapter (or book) file(s) with the staged indicator. The book then proceeds to the process of Charging 304 at block 412.

If not all lemmas on the list (for each chapter or for the book) have been examined, the next lemma on the list is examined at block 414. At block 416, the process determines whether the lemma is removed from the list (or confirmed as a lemma to be linked to a translation in at least one language). The decision at block 416 can be determined manually, using a list stored at the memory of the server 110, using artificial intelligence (AI), natural language processing (NLP), machine learning models, or the like, or a combination of the same. If the lemma is removed from the list, the next lemma on the list (if any) is examined, at blocks 408 and 414.

As “people are known by the company they keep,” so also lemmas are evaluated by the phrases with which they're associated within the book. Lemmas are evaluated based on their presence in certain word corpuses (which determines their difficulty or grade), and each word in each phrase containing the lemma undergoes a similar evaluation—this is how each phrase receives its score.

The confirmation of or removal of lemmas from the list of lemmas is done automatically according to this rule set. In other words, lemmas that do not appear in an “easy grade” word corpus may not be confirmed for an “easy grade” book variant, unless that lemma is found in a phrase with another “easy grade” lemma, and its own grade does not skew the grade level of the parent phrase too high.

At block 418, the process includes creating a list of the “basics” contained in the book file, by chapter or by book. A basic includes an independent clause (or “chunk”) of a sentence. Basics are grouped by any lemmas they have in common. For example, the basics “a dog,” “two dogs,” and “the big brown dog” are all basics grouped under the lemma “dog”.

If a lemma is to remain on the lemmas list, the “basic” containing the lemma is added to the “basics list” associated with that lemma at block 418. Each basic in a list associated to a chapter (or the book) is either confirmed as a basic to be linked to a translation in at least one language, or is removed from the list of basics. As each basic in the list is subsequently examined, at block 420, the process includes determining whether any basics remain to be examined.

If all basics on the list (for each chapter or for the book) have been examined, the lemma associated to the group of basics is confirmed at block 422. The process then proceeds to block 408, to determine if any lemmas remain to be examined.

If not all basics on the list (for each chapter or for the book) have been examined, the next basic on the list is examined at block 424. At block 426, the process includes removing the basic from the list if removal is determined. At block 428, the process includes confirming the basic as a basic to be linked to a translation in at least one language. The decision to remove or confirm a basic can be determined manually, using a list stored at the memory of the server 110, using artificial intelligence (AI), natural language processing (NLP), machine learning models, or the like, or a combination of the same. If the basic is confirmed or removed from the list, the next basic on the list (if any) is examined, at block 418.

The scoring criteria for each lemma in a given phrase (e.g., basic) influences the overall grade/difficulty of that phrase. Each book variant (described by its target language, density, and grade) has certain criteria or threshold for the (a) number and (b) type of phrases that are introduced. The described process of confirming a basic can be automated and so less prone to subjectivity (as human evaluation is less predictable than those done by machine).

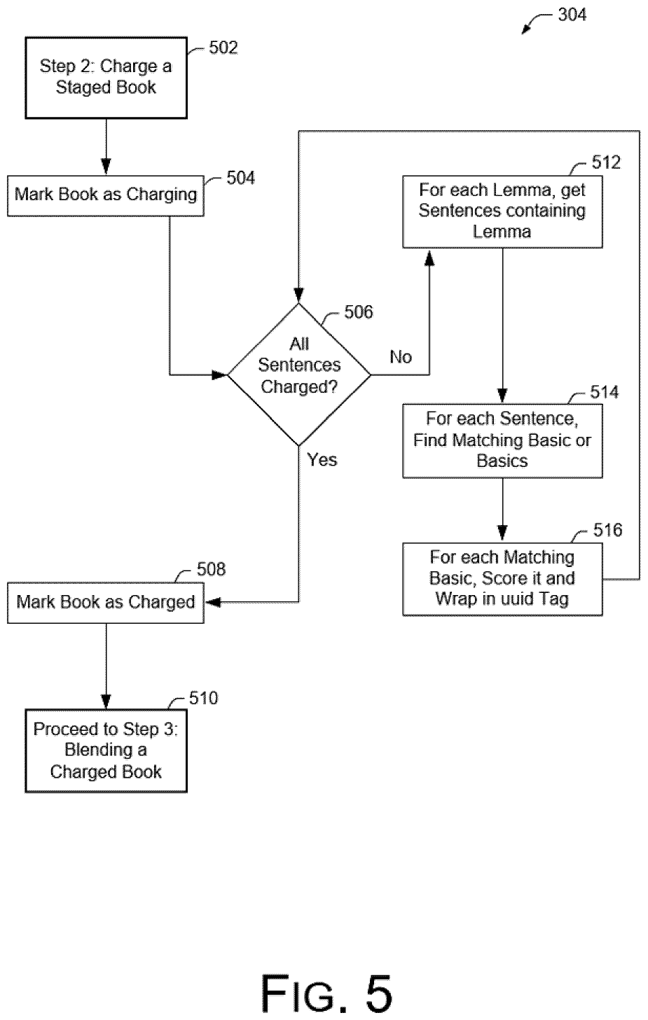

Referring to FIG. 5, a flowchart illustrates an example process of Charging 304, according to an embodiment. In various examples, a book cannot be transitioned to “Charging” if it has not been confirmed as “Staged” first. In various implementations, the process of Charging 304 can be performed at the server 110, or a like computing device. For instance, the process of Charging 304 can be accomplished at a hardware computing device (such as the server 110) with the aid of one or more of software, firmware, additional hardware, peripheral devices, a network connection, one or more electronic data storage components, and so forth. In some embodiments, the steps of the process of Charging 304 can be implemented via computer-readable instructions executed at a hardware computing device (e.g., server 110).

The process of Charging 304 prepares the staged book for blending, by identifying unique instances of basics in the sentences of the chapter (or book), referred to herein as “locals,” and tagging the locals with unique identifiers and descriptive attributes. Each local is uniquely identified, since seemingly identical locals in different sentences can have entirely different meanings. For instance, the local: “there was a large party” could refer to (a) a festive event or (b) a group of people.

At block 502, a “staged” book is introduced to the process of Charging 304. At block 504 the book is marked as “charging,” which can include attaching a tag to the book file(s).

During Charging 304, locals are given <local> tags with descriptive attributes (e.g., score=“3.78” or difficulty=“2”). Locals can be dependents of basics and inherit many of the properties of the associated basic, but the association going forward can be loose, as each local can be updated in isolation if appropriate. For instance, identical locals may have different translations depending on the context and meaning within the sentence/paragraph. Further, each local is given a translation reference (e.g., a pointer or link) to substitute words or phrases (in the second language) for each language in which the book will be published. As each sentence in the chapter or book is subsequently examined with its locals, at block 506, the process includes determining whether any sentences remain to be charged. The decision at block 506 can be determined manually, using a list stored at the memory of the server 110, using artificial intelligence (AI), natural language processing (NLP), machine learning models, or the like, or a combination of the same.

If all sentences have been charged, the book is marked as “Charged” at block 508. This can include adding a tag to the chapter (or book) file(s) with the charged indicator. The book then proceeds to the process of Blending 306 at block 510.

If not all sentences have been charged, then for each lemma on the list of lemmas, the sentences containing that lemma are retrieved at block 512. Multiple sentences containing a particular lemma might be retrieved at this stage. Each sentence may have a unique identifier assigned to it during the process of Charging 304 (or at another stage in the Production 210). At block 514, for each sentence retrieved, a basic (or multiple basics) having the lemma (e.g., matching the lemma) is identified. At block 516, each matching basic is scored and tagged with a unique identification (“uuid) tag. The uuid will be used to link a translation word or phrase (e.g., in the second language) to each basic for substitution into the variant of eBook 102 under construction.

In an example of block 512, all of the sentences in a chapter containing the lemma “dog” may be retrieved from the chapter. The retrieved sentences may include: (a) sentence #alb2c3: “the quick brown fox jumps over the lazy sleeping dog”; (b) sentence #d4e5f6: “Two dogs and a cat play together in the yard”; and (c) sentence #cdbefa: “My dog likes to fetch”.

In the example, at block 514 the basics of each of the retrieved sentences are identified from the sentences. The basics for the sentences retrieved include: (a) “the lazy dog”; (b) “Two dogs”; and (c) “My dog.”

In the example, at block 516, the basics are tagged with a uuid and given a score. The score is used to associate the tagged basic with a difficulty rating, for constructing a variant eBook 102 suitable for a reader at the difficulty level. In an example, the basics may be tagged and scored as: (a)<881fcl score=“1.59” difficulty=“1”> the lazy dog</881fcl>; (b)<a7713c score=“1.33” difficulty=“1”> Two dogs</a7713c>; and (c) <32dfal2 score=“1.53” difficulty=“1”> My dog</32dfal2>.

Scores or “grades” can be assigned to a portion of text, such as a word, phrase, basic, chunk, and so forth. In some examples the scoring or grading can be accomplished using AI, machine learning, and so forth, and/or according to a proprietary algorithm. In some cases, scoring or grading includes determining whether words contained in the portion of text are listed in an assembled corpus or collection of words. In those cases, the score can be determined by which corpus or corpuses the words show up in, as discussed further below. In some cases, scoring or grading techniques can be performed based on the words and phrases contained in an entire book, rather than in smaller portions of the book.

These unique tags and scores (generated at the server 110 as described above) can be inserted into the originally retrieved sentences as follows: (a) sentence #alb2c3: “the quick brown fox jumps over <881fcl score=“1.59” difficulty=“1”> the lazy dog</881fcl>”; (b) sentence #d4e5f6: “<a7713c score=“1.33” difficulty=“1”> Two dogs</a7713c> and a cat play together in the yard”; and (c) sentence #cdbefa: <32dfal2 score=“1.53” difficulty=“1”> My dog</32dfal2> likes to fetch.”

Following block 516, the process loops back to block 506, and repeats blocks 506, 512, 514, and 516 until all of the sentences in the chapter (or book) are charged. The process proceeds to Step 3: Blending a Charged book at block 510.

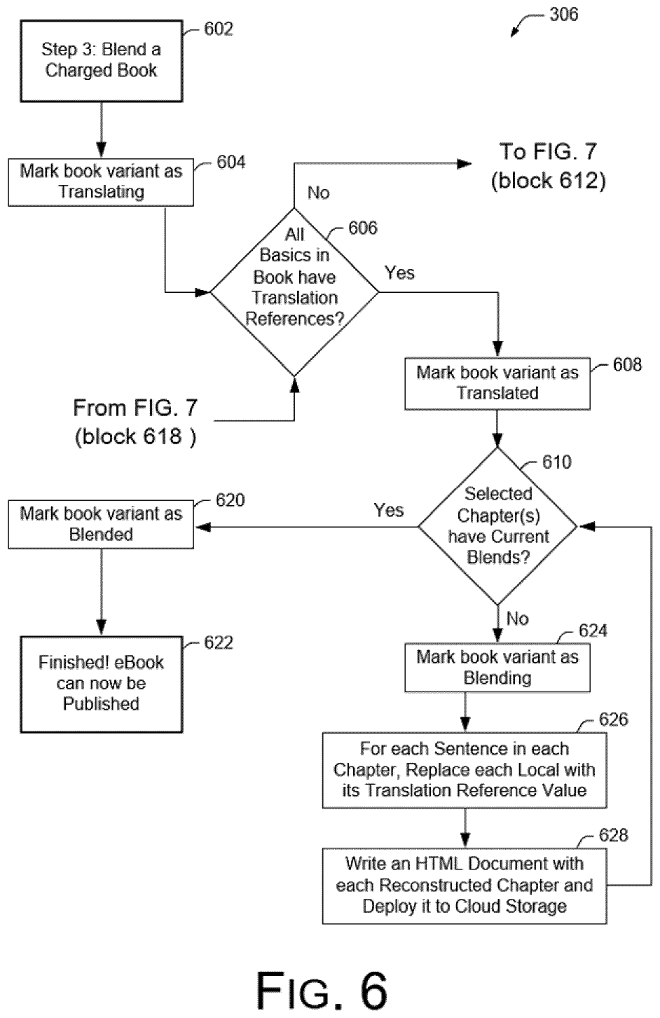

Referring to FIG. 6, a flowchart illustrates an example process of Blending 306, according to an embodiment. In various examples, a book cannot be transitioned to “Blending” if it has not been confirmed as “Charged” first. In various implementations, the process of Blending 306 can be performed at the server 110, or a like computing device. For instance, the process of Blending 306 can be accomplished at a hardware computing device (such as the server 110) with the aid of one or more of software, firmware, additional hardware, peripheral devices, a network connection, one or more electronic data storage components, and so forth. In some embodiments, the steps of the process of Blending 306 can be implemented via computer-readable instructions executed at a hardware computing device (e.g., server 110).

The process of Blending 306 takes a charged book and finalizes the book for publishing, by substituting locals or unique instances of basics within sentences of a chapter (or book) with words or phrases in a second language to form an eBook 102 variant. In other words, a language variant eBook 102 is formed by a process of substituting source language words and phrases (in a first language) for corresponding translated words and phrases in a second language.

At block 602, a “charged” book is introduced to the process of Blending 306. At block 604 the book is marked as “translating,” which can include attaching a tag to the book file(s). In an embodiment, translating can refer to a stage of an individual language variant for a book, in which the Translation API is being actively queried for missing translation references. In that case, the component words and phrases of a charged book that is introduced to the process of Blending 306 are translated with a particular (second) language and blended with the book as a unique variant of that language (based on score, difficulty, etc.) out of a multiplicity of possible variants.

During “translating,” each tagged local or basic is assigned a translation via a translation reference. A translation reference can point to (or link to) a word or phrase in a second language that can be substituted into a sentence in the book in place of the tagged local or basic. The translation word or phrase has a unique identification tag (“uuid”) and may include one or more other attributes. Translation references point to translations in various “second languages” that can be stocked, stored, made available, or archived at the server 110 storage or a network location, so that various language variants of an eBook 102 title can be generated as desired.

In various embodiments, translations (in one or multiple languages) can be obtained from tables, spreadsheets, databases, and the like, or they can be obtained via AI and/or other machine learning modes.

As each basic in the chapter or book is subsequently examined with its locals, at block 606, the process includes determining whether all basics have translation references. The decision at block 606 can be determined manually, using a list stored at the memory of the server 110, using artificial intelligence (AI), natural language processing (NLP), machine learning models, or the like, or a combination of the same.

If all basics have translation references, the book variant is marked as “translated” at block 608. This can include adding a tag to the chapter (or book) file(s) with the translated indicator. The book then proceeds to the process of blending a translated variant at block 610.

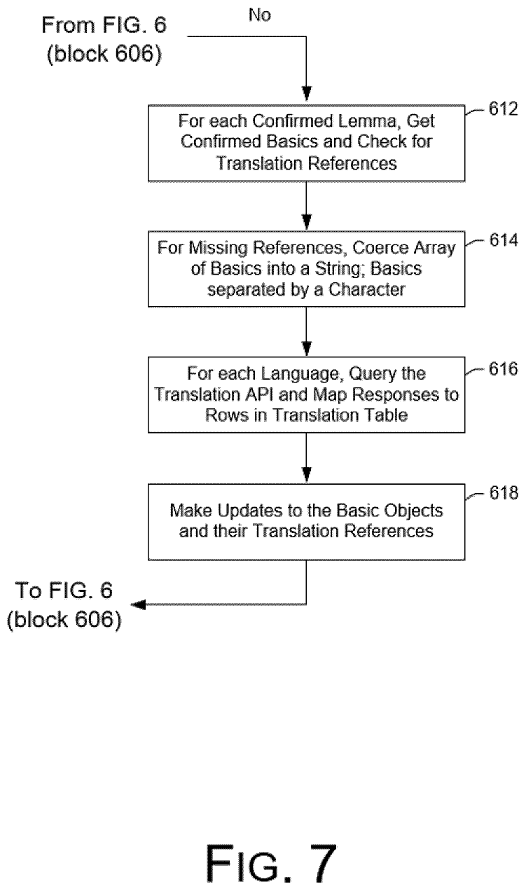

If not all basics have a translation reference, then the process continues at block 612 (which is illustrated at FIG. 7). At block 612, for each confirmed lemma, confirmed basics are retrieved, and the process checks that each confirmed basic has a translation reference. Note that each book has a property “lemmas,” which can be a “dict” in some coding languages (such as Python, for example) with keys (lemmas) and values (array of strings of basics). If one or more basics is missing a translation reference, the query can be made more efficient by combining the basics that are missing a reference and performing a group query. In an embodiment, at block 614, the basics that are missing a translation reference are rearranged from a list or an array and into a string. The individual basics can be separated by a newline character or some other character recognized by the process as separating the basics from one another. In alternate embodiments, the basics needing translation references may be organized differently prior to performing the query at the translation API. Note that submitting a large number of basics allows one query to be made to the translation API for the whole batch, rather than making individual requests for each basic.

At block 616, the translation references for the basics are obtained via a routine wherein the Translation API is queried for missing translation references and responses are mapped to rows or cells in a translation table or the like (e.g., a SQL table). As mentioned above, the Translation API may obtain the translations and associated references from tables, spreadsheets, databases, and the like, which may be local or remote (networked) to the server 110, or they can be obtained via AI and/or other machine learning modes. For example, the translations may be generated or stored in a cloud-based resource that is networked to the server 110. Note that each basic has a property “translations,” which can be a “dict” in some coding languages (such as Python, for example) with keys (languages) and values (uuid references to PKs in the translation table).

At block 618, the process includes making updates that associate, tag, link, reference, etc., the basics to their translation references (for the one or more “second languages”). The process then returns to block 606 to re-check whether all basics in the book have translation references.

Moving to block 610, when the book variant has been marked as translated (at block 608), the process includes “blending” the book to form the eBook 102 variant desired. In other words, the sentences of the chapters of the book are blended, which comprises substituting “second language” words and phrases for the “first language” basics, according to the desired variant. At block 620, the process includes checking that all of the selected chapter(s) have current blends. When all of the selected chapter(s) have current blends, the book variant is marked as “blended.” The process of producing a blended eBook 102 is finished, and the eBook 102 can be published at block 622.

If not all of the selected chapter(s) have current blends, the book is marked as “blending” at block 624. This can include adding a tag to the chapter (or book) file(s) with the blending indicator. At block 626, for each sentence in each chapter, the process includes replacing each local with its translation reference value. The translation reference value is the word or phrase in the second language that is referenced by the translation reference attached to the local (e.g., basic). This is facilitated via the uuid tagged to each local, each sentence, and each translation value. Note that this part of the process includes collecting and processing in like manner each paragraph from each chapter and each sentence from each paragraph.

At block 628, the process includes writing a digital document, using HTML, XML, JavaScript Object Notation (JSON), or other digital format, comprising each “reconstructed” chapter of the book. The reconstructed chapters are those that have the locals replaced with the translation reference values. In other words, the locals are replaced with words and phrases in the “second language” corresponding to the translation references. Note that in some examples, each chapter iterates on its own build number.

Referring back to block 622 and also FIG. 3, the digital documents of the reconstructed chapters are stored at a digital storage associated to the server 110, which may comprise a cloud storage, or the like. The reconstructed chapters are linked to form the completed eBook 102, which constitutes Publishing 308 the eBook 102. The published eBook 102 is available for access by a user through the Storefront App 114.

Based on the Production 210 processes, any updates or corrections to a published eBook 102 are easily performed. As shown at FIG. 3, correcting and/or updating an eBook 102 can include pulling the eBook 102 from Publishing 308 (the eBook 102 may not be available to users during this process) and running the book or one or more chapters through one or more of the Staging 302, Charging 304, and Blending 306 stages, depending on the correction/update made. Once completed with the Blending 306 stage, the eBook 102 can be published (308) again, to be available to users.

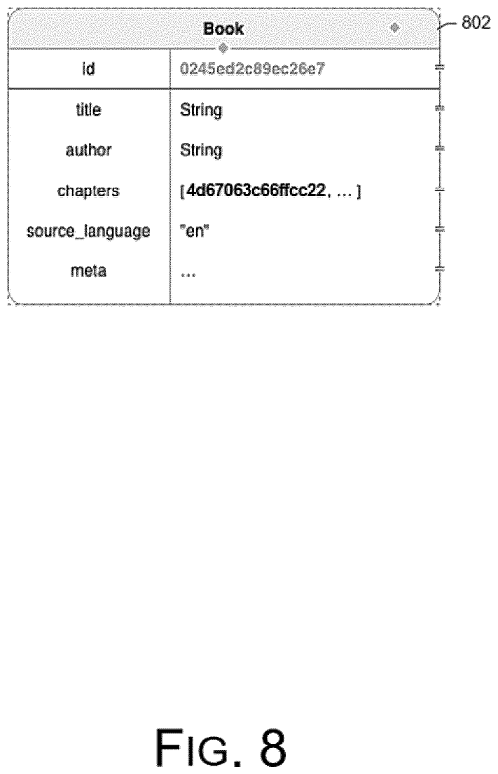

FIGS. 8-14 illustrate examples of attributes, tags, metadata, characteristics, and the like that may be attached to a book, a chapter, or portions thereof, and so forth. The attributes, tags, metadata, characteristics, and the like can be attached to portions of the book at various points within production 210 processes, such as processing by the server 110, for example, wherein the book is parsed into its smaller components. As mentioned, this makes it easier to edit the sentences in isolation, and provides that when a book is being updated and reconstructed, all of the components will be put back together in the right order.

For example, as shown in the figures, when books are broken down into their components, the components are tagged to identify the parent components and may also include child components or component references. Primary keys (PK) and secondary keys (SK) can be used to maintain these family relationships. In an example, the book has a PK which is a unique identifier (“uuid”). The chapters of the book have a PK uuid, as well as a SK: book.uuid#index, which identifies the parent book and the relative placement of the chapter within the book. The paragraphs within the chapters each have a PK uuid, as well as a SK: book.uuid#chapter.uuid#index, which identifies the parent book, the parent chapter, and the relative placement of the paragraph within the chapter. The sentences within the paragraphs each have a PK uuid, as well as a SK: book.uuid#chapter.uuid#paragraph.uuid#index, which identifies the parent book, the parent chapter, the parent paragraph, and the relative placement of the sentence within the paragraph.

The attributes, tags, metadata, characteristics, and the like can also be used to form the variants of eBooks 102, to automate the processes, and to provide links and attachments. While some attributes are shown, additional or alternate attributes are also possible. For instance, at FIG. 8, example attributes 802 for a book are illustrated. The attributes include a Primary Key (PK) unique identifier (“id”) for the book, a text string for the title and the author, which identifies the parent database table(s), unique identifiers for each chapter of the book, and a source language designator (e.g., “en” for English). In some examples, other metadata are also attached to the book.

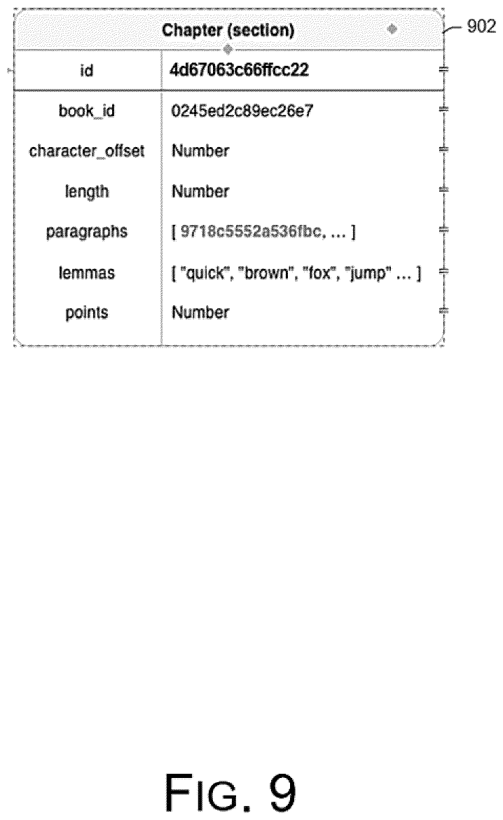

Referring to FIG. 9, example attributes 902 for a chapter of the book are illustrated. The attributes include a unique (PK) id for the chapter (which is included in the chapter identifiers listed at the book), a Secondary Key (SK) id that comprises the PK for the book (linking the chapter to the book), a number representing where the chapter appears in the book (character offset from the start of the book), a number representing the length of the chapter (in characters), unique identifiers for each paragraph of the chapter, a listing of the lemmas in the chapter, and a number of points. Points can refer to both: (a) the readability score, which is determined by various algorithms (like Flesch-Kincaide Grade, Coleman-Liau Index, and McAlpine EFLAW); and (b) the cumulative score of translated phrases contained in the chapter. Note that readability scores may be calculated at the server 110, but often readability scores are imported from available sources such as the algorithms listed above and the like.

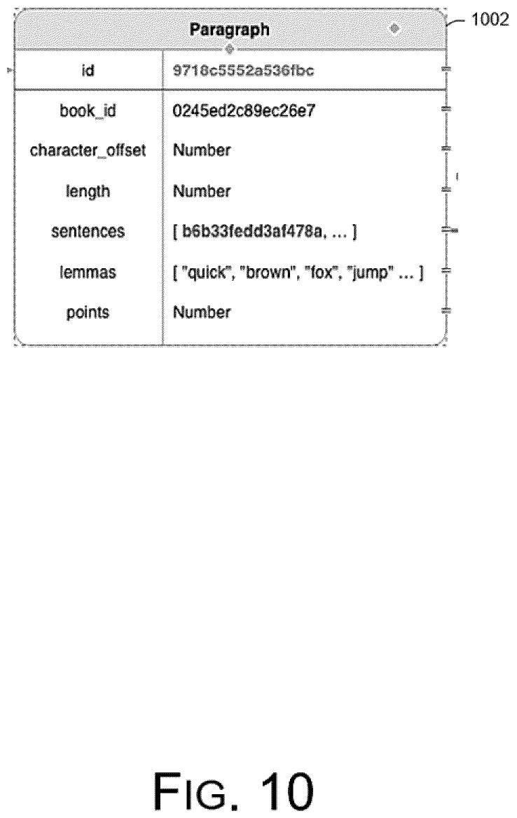

Referring to FIG. 10, example attributes 1002 for a paragraph of the chapter are illustrated. The attributes include a unique (PK) id for the paragraph (which is included in the paragraph identifiers listed as attributes at the chapter), the unique (SK) id for the book, the unique id for the chapter (linking the paragraph to the chapter), a number representing where the paragraph appears in the book (character offset from the start of the book) (this could also be indicated by a number of characters from the start of the chapter), a number representing the length of the paragraph (in characters), unique identifiers for each sentence of the paragraph, a listing of the lemmas in the paragraph, and a number of points. In an example, paragraphs are delineated by a selected character, such as a double line break, or the like.

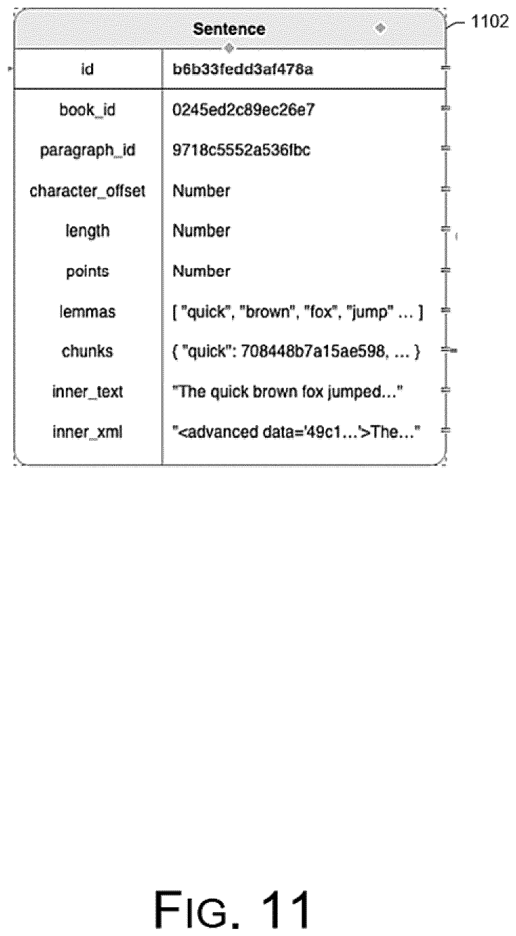

Referring to FIG. 11, example attributes 1102 for a sentence of the paragraph are illustrated. The attributes include a unique (PK) id for each sentence (which is included in the listing of sentence identifiers at the paragraph), the unique (SK) id for the book, the unique id for the chapter, the unique id for the paragraph (linking the sentence to the paragraph), a number representing where the sentence appears in the book (character offset from the start of the book) (this could also be indicated by a number of characters from the start of the paragraph or chapter), a number representing the length of the sentence (in characters), a number of points, a listing of the lemmas in the sentence, a listing of the chunks in the sentence with unique identifiers, a text string of the inner text of the sentence, and the inner XML text of the sentence (showing the inner text plus the XML tags). For example, a sentence object can contain raw text in the form of a text string. In embodiments, sentences can be recognized by NLP software.

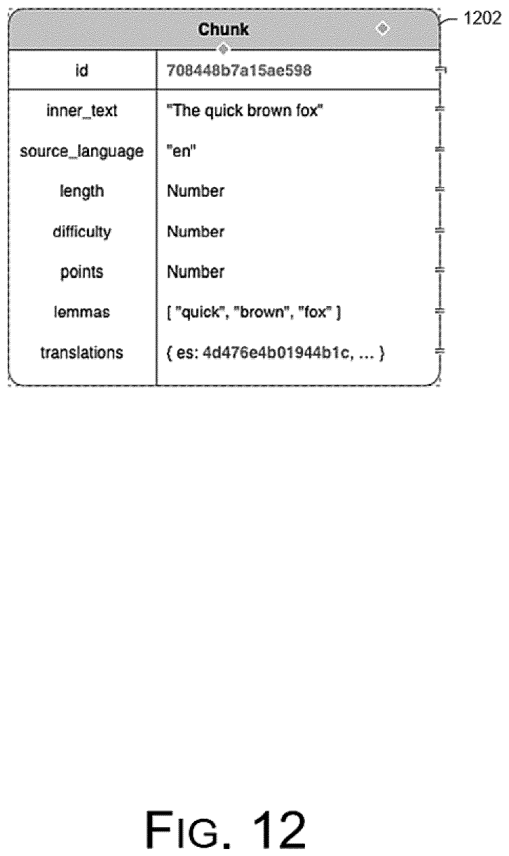

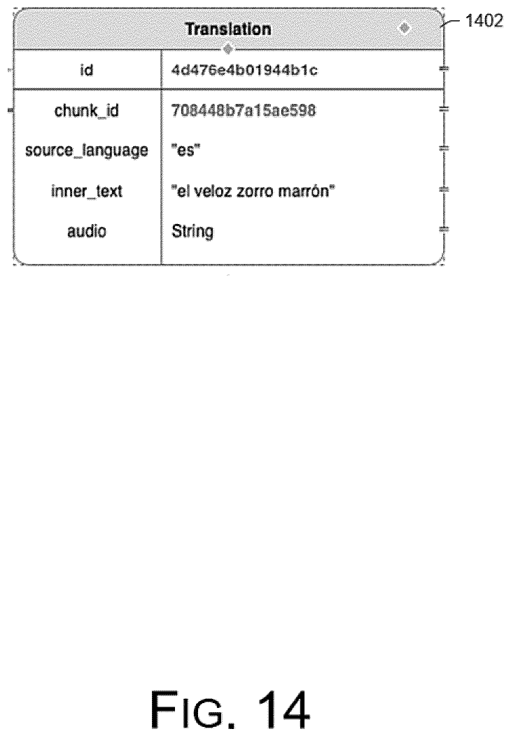

Referring to FIG. 12, example attributes 1202 for a chunk (a.k.a. basic) of a sentence are illustrated. The attributes include a unique (PK) id for the chunk (which is included in the list of chunk identifiers at the sentence). The unique (SK) id for the book, the unique id for the chapter, the unique id for the paragraph, and/or the unique id for the sentence may also be included. The inner text of the chunk is given, as well as the source language, and a number representing the length of the chunk (in characters), a number representing the difficulty, a number of points, and a listing of the lemmas in the chunk. Additionally, a listing of the unique identifiers (uuid's) of translations of the chunk in various languages is also given. Chunks are not dependents of the sentences in which they are found, but they do contain attributes like inner text, length, and difficulty. Chunks also hold references to translations (see FIG. 14). Like sentences, chunks can hold a raw text sting as an attribute. In some cases, a chunk may be agnostic to the book—pointing a single translation for a repeating set of words or phrases (that do not need to be re-translated again and again).

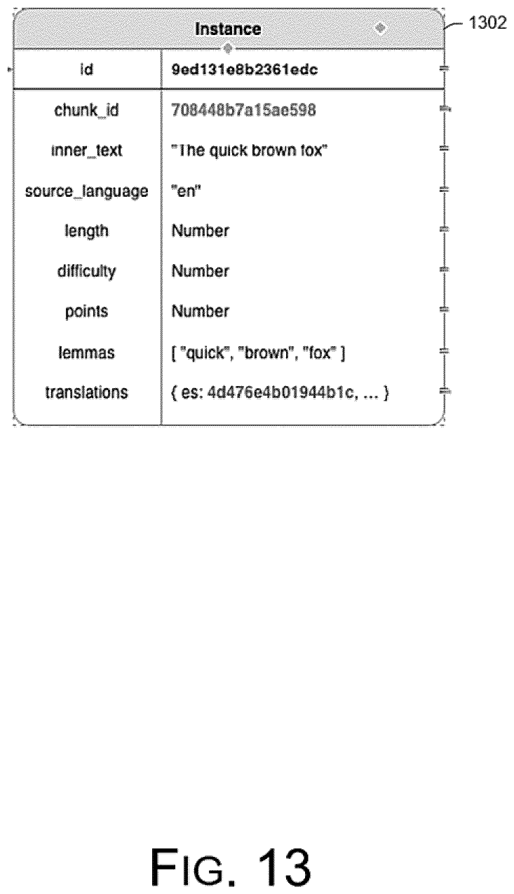

Referring to FIG. 13, example attributes 1302 for an instance (a.k.a. local) of a chunk (a.k.a. basic) of a sentence are illustrated. While identical chunks may appear in the eBook 102, each unique instance of a chunk is tagged for individual translation (e.g., substitution with a phrase or words in the second language) since the translation may differ for unique chunks. The attributes include a unique (PK) id for the instance and a unique (SK) id for the chunk (which is included in the list of chunk identifiers at the sentence). The unique id for the book, the unique id for the chapter, the unique id for the paragraph, and/or the unique id for the sentence may also be included. The inner text of the chunk is given, as well as the source language, and a number representing the length of the chunk (in characters), a number representing the difficulty, a number of points, and a listing of the lemmas in the instance. Additionally, a listing of the unique identifiers (uuid's) of translations of the instance in various languages is also given. In other words, the attributes of an instance points to a PK of a translation, for each language translated. The attributes of an instance also include a raw-text text string.

Referring to FIG. 14, example attributes 1402 for a translation of an instance (a.k.a. local) of a chunk (a.k.a. basic) of a sentence are illustrated. The attributes include a unique (PK) id for the translation and a unique (SK) id for the chunk (which is included in the list of chunk identifiers at the sentence). The unique id for the book, the unique id for the chapter, the unique id for the paragraph, and/or the unique id for the sentence may also be included. The source language of the translation is given (e.g., “es” for Spanish, etc.) and the inner text of the translation is also given. A string representing “audio” of the translation is also given, which can refer to a location (URL) of an audio file, for example, if there is one. The text and language values are both text strings.

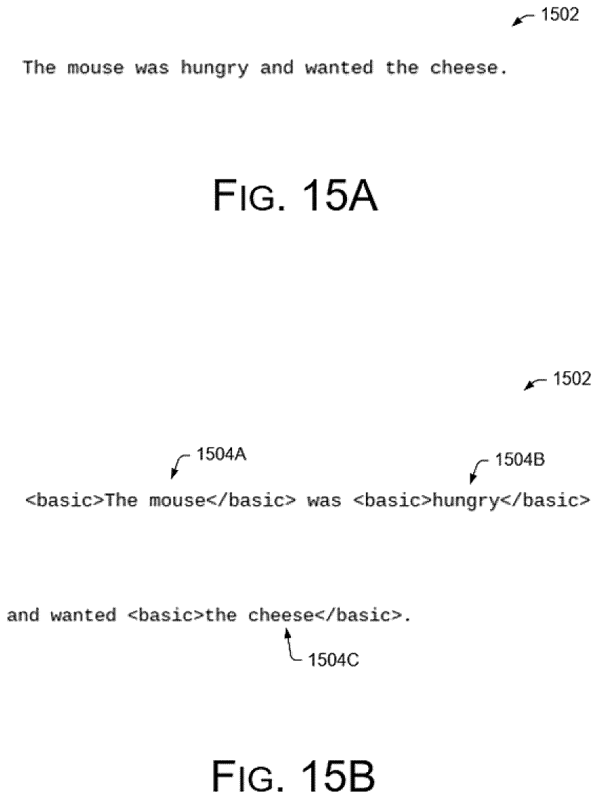

FIG. 15A shows an example sentence 1502 prior to translation and blending. In the example, the sentence 1502 comprises the text “The mouse was hungry and wanted the cheese.” The sentence 1502 is an example of a sentence that can be from a paragraph of a chapter of a book, as described above with reference to Production 210. The sentence 1502 can have the sentence attributes 1102 associated to it, as shown at FIG. 11, for example.

As discussed above, the basics contained in the sentence can be identified (see FIGS. 4 and 5) by identifying the simplest noun phrases and adjectives of the sentence 1502. The basics 1504 contained in the example sentence 1502 include: basic 1504A: “The mouse”; basic 1504B: “hungry”; and basic 1504C: “the cheese.” Note that each basic 1504 includes a lemma: 1504A: “mouse”; 1504B: “hungry”; and 1504C: “cheese.”

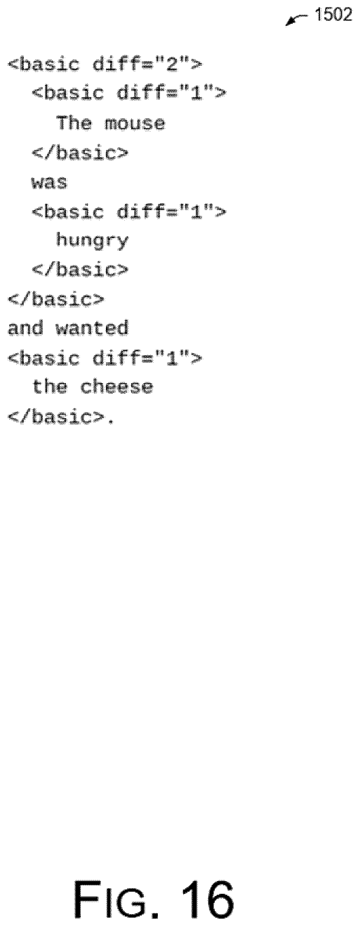

Referring to FIG. 16, the sentence 1502 can be written to include a difficulty score attribute for each of the basics 1504 (see FIG. 5). For instance, each of the basics 1504 in the example sentence 1502 receives a difficulty score of 1: “<basic diff=“1”>”. Note that in FIG. 16 the sentence 1502 is shown in a column format, such as written in HTML, XML, and like notation.

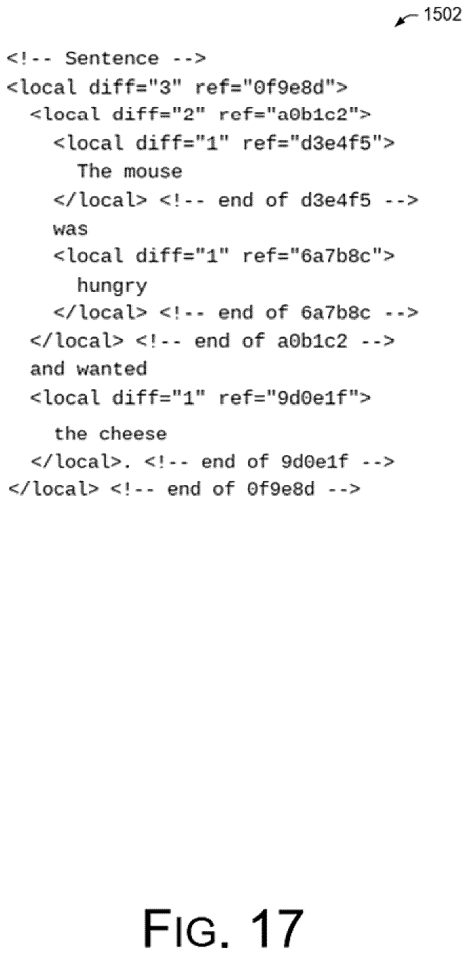

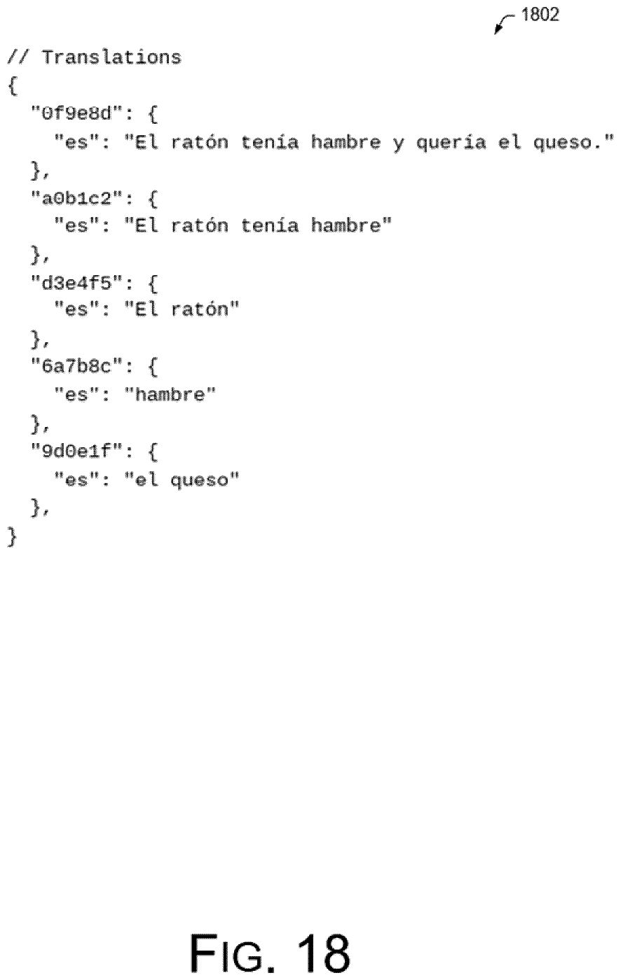

Referring to FIG. 17, after the basics 1504 in a sentence 1502 have been identified, the basics 1504 can be reassigned and tagged as locals during the Charging 304 stage with references to translation objects (see FIG. 5). As shown at FIG. 17, each of the basics have a “local difficulty” score of “1”, and include a corresponding uuid reference for a matching translation object. The translation objects 1802 are shown at FIG. 18, and can be matched by uuid references (as shown at FIG. 17) to the basics 1504 and the sentence 1502.

For example, the uuid “0f9e8d” is associated to the sentence 1502, and has a translation object (in Spanish in this example) corresponding to the uuid “0f9e8d,” comprising: “El raton tenia hambre y queria el queso.” Then, the uuid “a0b1c2” is associated to a first basic, which has a translation object corresponding to the uuid “a0b1c2,” comprising: “El raton tenia hambre.” Next, the uuid “d3e4f5” is associated to the local “the mouse,” which has a translation object corresponding to the uuid “d3e4f5,” comprising: “El raton.” Then, the uuid “6a7b8c” is associated to the local “hungry,” which has a translation object corresponding to the uuid “6a7b8c,” comprising: “hambre.” Finally, the uuid “9d0elf” is associated to the local “the cheese,” which has a translation object corresponding to the uuid “9d0elf,” comprising: “el queso.”

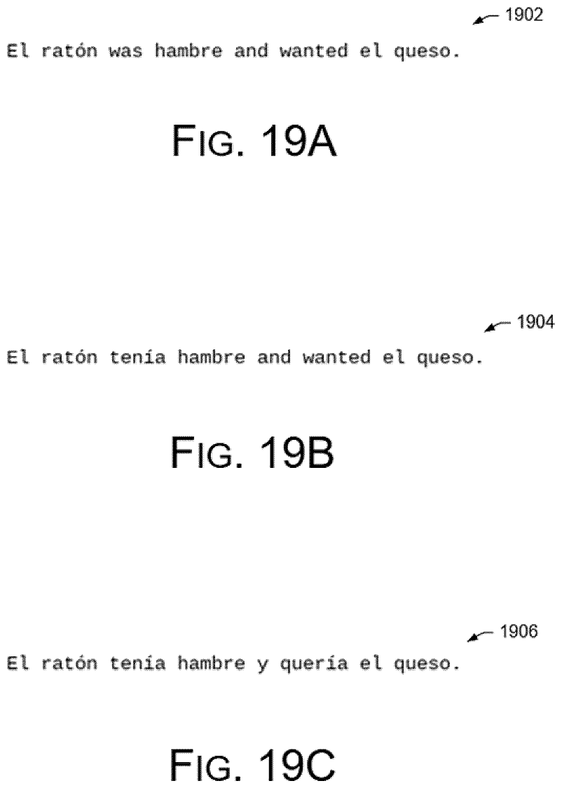

Referring to FIGS. 19A-19C, each sentence 1502 is reconstructed with an HTML, XML, etc. string according to its basics 1504. The inner HTML attribute of the sentence 1502 can become the new HTML string marked with instances. Using RegEx matching (or the like) and the translation reference attributes in the inner text string, each difficulty variant of the sentence can be constructed as shown. For instance, a beginner level (difficulty=1) construction of a blended sentence 1902 is shown at FIG. 19A: “El raton was hambre and wanted el queso.” Note that for difficulty level 1, some few words (in this example, the noun basics) are translated to the “second language,” in this case Spanish. The remainder of the words in the sentence are in the “first language,” in this case English.

Additionally, an intermediate level (difficulty=2) construction of a blended sentence 1904 is shown at FIG. 19B: “El raton tenia hambre and wanted el queso.” Note that for difficulty level 2, additional words are translated to the “second language.” Finally, an advanced level (difficulty=3) construction of a blended sentence 1906 is shown at FIG. 19C: “El raton tenia hambre y queria el queso.” Note that for difficulty level 3, additional words are translated to the “second language,” which may include all of the words in the sentence.

In alternate examples, there can be fewer or additional difficulty levels. Further, in some examples, words selected to be translated in the second language may be based on the user's interest (e.g., various words relating to an area of study or interest are translated or not translated), the technical nature of the book (e.g., technical words relating to an area of study or interest are translated or not translated), the goal of learning the second language (e.g., various words that build on a reader's abilities are translated or not translated), and so forth. These factors can be applied to blending a unique eBook 102 title using AI, machine learning, and the like. Accordingly, with at least the variables mentioned, plus others that can be contemplated, an eBook 102 title could be blended in thousands of different ways—with different words or phrases in the first and second (or more) languages.

In various embodiments, further book reconstruction is performed to prepare the eBook 102 for publication. For example, after all of the sentences in a book have been outfitted with their HTML instance strings (when the book is considered Charged and has at least one language marked as Translated), book reconstruction produces HTML or XML, etc. documents for each chapter. Some conventions can be used to indicate the starting and ending points of sentences, paragraphs, chapters, and so forth.

In one example, sentences in a paragraph can be ordered by index and joined together via a character, such as a whitespace (‘ ’) character, or the like. Paragraphs in a chapter can be wrapped with <p>_</p> tags and ordered by index. Chapters in an eBook 102 can become their own HTML, XML, etc. document with requisite <head> and <meta> information. For example, an eBook 102 with 12 chapters could have 12 nested documents, not including front matter, table of contents, etc. Each chapter can have a variant for each language and difficulty available at the time. For example, with beginner and intermediate difficulties, there would be 2 variants of the same chapter for each language.

Users who add an eBook 102 to their bookshelf (e.g., storefront 114 portal) can download, stream, etc. the raw HTML, XML, JSON, etc. chapters of that eBook 102 that correspond to their target language and difficulty level. Should the user change their preferences, a different version of the eBook 102 will be downloaded, streamed, etc. on a first open of the eBook 102 after the changed preferences. In some cases, the user can be prompted to update one or more eBooks 102 (or all eBooks 102) in the user's bookshelf after updating language or difficulty preferences. In other cases, the user can be prompted to update one or more eBooks 102 (or all eBooks 102) in the user's bookshelf after a correction or an update has been made to one or more of the eBooks 102 (depending on the scope of the correction/update).

### Example Variants, Scoring, and Priorities

Variants of eBook 102 titles can have different densities. The density of a blended eBook 102 refers to the ratio or percentage of words translated to the second language to words that remain in the first language after blending. A non-limiting example of densities includes: Low: 5%, Medium: 10%, High: 20%, and Very high: <33%.

In some cases, the density of the eBook 102 can be ramped as the reader progresses through the eBook 102. In non-limiting examples, density ramping can include: None: stay at same density throughout book (can be available on low, medium, high); Gradual: next level up over length of book (available on low, medium, high); Moderate: level after next over length of book (available on low, medium); and Steep: to “very high” over length of book (available only on low).

Variants of eBook 102 titles can have different scores or grades. Scoring or grading, which determines the “difficulty” of an eBook 102, can be determined by various techniques, including proprietary algorithms disclosed herein. In an example, each chunk can be assigned a score using the word tokens it contains. Neither stop words nor punctuation may be scored. However, stop words can be counted in the overall word count of the parent chunk. For example: Score by rank, c_rank, or SFI; Use mean or root mean square; Easy: mean token score is <2, no token scores higher than 3; Intermediate: mean token score is <3, no token scores higher than 4; Hard: mean token score is <4; and Obscure: mean token score is >4.

Using a scoring technique, the number and type of translated (e.g., substituted) lemmas in a section of text can be determined using one or more of the following priority methods: 1. Current: empty at start, prioritizes book position; 2. Focused: Academic: prioritizes NAWL corpus; Business: prioritizes BSL corpus; Fitness: prioritizes FEL corpus; 3. Grade: Newbie (0): prioritizes NDL corpus, introduces up to one new lemma per chunk; Sort A: descending (most frequent first); Sort B: ascending (least frequent first); Sort C: distance from median frequency; Sort D: random; Beginner (1): prioritizes NGSL Core. Falls back to NDL. Introduces up to two new lemmas per chunk. Same sort variants as Newbie (0). Intermediate (2): prioritizes TSL. Falls back to NGSL Core & NDL. Introduces up to three new lemmas per chunk. Same sort variants as Newbie (0). Advanced (3): prioritizes NGSL beyond NGSL Core. Falls back to TSL, NGSL Core, & NDL. No limit on how many lemmas can be introduced in a given chunk. Same sort variants as Newbie (0); 4. Local: Book: prioritizes most-frequent lemmas in each book, prioritized by SFI; Chapter: prioritizes most-frequent lemmas in each chapter, prioritized by SFI; 5. Stop words: Use standalone words like ‘she’ and ‘anybody’ to meet density threshold; 6. User Negative: Words that the user has seen/learned in previous books; 7. NGSL: prioritizes (e.g., 2800) top words in NGSL corpus. Note that the corpuses mentioned herein are non-limiting examples of how corpuses can be used in prioritization. Since a large number of corpuses exist, a person having skill in the art will appreciate that in various embodiments additional or alternate corpuses to those mentioned can be used in like manner for prioritization.

Example scoring formulas can include: Dale-Chall: 0.1579×(difficult words÷words×100)+0.0496×(words÷sentences); McAlpine EFLAW: (words+miniwords)÷sentences; Automated Readability Index: 4.71×(characters÷words)+0.5×(words÷sentences)−21.43; and Flesch-Kincaid Readability Index.

In various embodiments, the above techniques can be applied as follows to build the priority slots for substituting lemmas. Pass over the entire book once. Along the way, build dictionaries for individual chapters (of lemmas and the number of times they appear), and aggregate the findings into a dictionary for the book as a whole.

At this stage, the focus is lemmas (that aren't stop words or punctuation). Keep track of how many times each of the lemmas appear. Again, aggregate the counts from each chapter into the overall book.

Once the consolidated book dictionary is formed, use the lemma count to help establish scores. Using the NGSL standardized frequency index (SFI), the dispersion, and the count of each lemma, calculate a score for each lemma in the dictionary, which informs the lemma's priority. This creates Priority Slot 4A: Local Book.

Each chapter also has a dictionary, and it uses the same scoring mechanism as the book dictionary. The main difference is that a lemma may have more or fewer appearances in a given chapter, affecting its priority within that chapter. This creates Priority Slot 4B: Local Chapter.

Priority Slots 2A, 2B, and 2C (Focused) can then be generated using matching entries from their respective lists with the Book Dictionary. Priority Slots 3A, 3B, 3C, and 3D (Difficulty) can be generated in the same way. Each difficulty level prioritizes certain lists within the NGSL universe.

The priority slots can be used as in the following example: Pass through the book a second time with these Priority Slots. Go over each chapter, and within each chapter go over each paragraph. Track the word count of each paragraph, and add the entire paragraph to a list, until the word count of all the paragraphs in the list is greater than a preselected value. Look at each lemma in each chunk, and see where each lemma is found in the Priority Slots:

If the lemma has been introduced already, its parent chunk will be selected for the next step. If the lemma appears in a Focused word corpus, its parent chunk will be selected for the next step. If the lemma appears in either of the Book or Chapter dictionaries, its parent chunk will be selected for the next step.

All parent chunks in the paragraphs list will be prioritized and scored according to their child lemmas (excluding stop words). Prioritization can be more important than score when comparing lemmas in different Priority Slots. In other words, lemmas in the Focused Priority Slot will be introduced before lemmas in the Book or Chapter Priority Slots, regardless of their score. Lemmas in the Introduced Priority Slot will always rank above lemmas in every other Priority Slot.

Each density level informs how many chunks per paragraphs list will be selected for translation. For the lowest density, 5 words in every 100 (5%) are selected for translation, with certain tolerances allowing some overages. Medium and high densities both double the density of their predecessor. Very high density caps out at 33% saturation.

The chunks with the highest-priority lemmas will be selected first, then the highest-scoring chunks.

Once the chunks from each paragraph list have been selected (according to the density criteria and their difficulty scores), their indexes are used to create a dictionary for that paragraph (whose index is also marked). Each lemma is moved, along with its score, to the Introduced Priority Slot (if it isn't there already), where it will remain for the rest of the book.

The techniques disclosed herein are intended to be non-limiting examples. Additional or alternate steps may be included and remain within the scope of the disclosure. Further, additional ranges (or altered ranges) with greater or lesser values are also contemplated for densities, difficulty, priority, and so forth.

FIGS. 1-19 are not intended to be restrictive, and the components may have additional or alternate components, and so forth, while performing the functions (or equivalent functions) described herein, and without departing from the scope of the disclosure.

In alternate embodiments, other or additional components may be used for the described functionality, and remain within the scope of the disclosure. Although various implementations and examples are discussed herein, further implementations and examples may be possible by combining the features and elements of individual implementations and examples.

In various embodiments, the system 100, may be added to an existing arrangement (such as existing e-reader applications, for example). For instance, the existing arrangements may be retrofitted with the system 100 or with system 100 components. In other embodiments, the system 100 may be a part of a new arrangement, such as a new e-reader application, or the like.

### CONCLUSION

Although the implementations of the disclosure have been described in language specific to structural features and/or methodological acts, it is to be understood that the implementations are not necessarily limited to the specific features or acts described. Rather, the specific features and acts are disclosed as representative forms of implementing the claims.

What is claimed is:

1. A method of producing an electronic book, comprising:
providing a book in a first language in digital form;
deconstructing the book into a plurality of component sentences;
identifying and tagging one or more basics of the plurality of component sentences, each basic containing a lemma;
determining a respective translation in a second language of each basic of the one or more basics;
substituting the respective translation of at least one basic of the one or more basics of at least one sentence of the plurality of component sentences, according to an applied rule, to form at least one blended sentence; and
reconstructing the book to include the at least one blended sentence to form one of a plurality of variants of the electronic book.

2. The method of claim 1, further comprising deconstructing the book into a plurality of chapters and a plurality of paragraphs and tagging each of the chapters of the plurality of chapters with a unique identifier and tagging each of the paragraphs of the plurality of paragraphs with a unique identifier.

3. The method of claim 2, further comprising using natural language processing to perform the deconstructing.

4. The method of claim 1, further comprising linking the respective translation to the at least one basic by referencing a unique identifier of the respective translation via a markup tag at the at least one basic.

5. The method of claim 1, further comprising reconstructing the book to form variants of the electronic book in a plurality of languages and at a plurality of difficulty levels.

6. The method of claim 1, further comprising reconstructing the book to form variants of the electronic book in a plurality of densities, wherein a density comprises a ratio of a quantity of words in the second language to a quantity of words in the first language.

7. The method of claim 6, further comprising reconstructing the book to form variants of the electronic book in which a density of the variant increases from a start of the book to an end of the book.

8. The method of claim 1, further comprising providing a list of translations in one or more languages of each basic of the one or more basics and attaching a unique identifier to each of the translations of the list of translations.

9. The method of claim 8, further comprising using machine learning techniques or artificial intelligence to form the list of translations.

10. The method of claim 1, further comprising publishing the plurality of variants of the electronic book at a digital bookstore.

11. The method of claim 1, wherein the applied rule is based on user skill level.

12. The method of claim 1, wherein the blended sentence includes one or more words in the first language and one or more words in the second language.
